(19) United States
(12) Patent Application Publication
(10) Pub. No.: US 2001/0017092 A1
(43) Pub. Date: Aug. 30, 2001

(54) Switching device for ground-effect vehicles, and a transport installation comprising such a device

(75) Inventor: Alain Mollet, Annecy Le Vieux (FR)

Correspondence Address: Clarence A. Green, PERMAN & GREEN, LLP, 425 Post Road, Fairfield, CT, 06430, US

(73) Assignee: POMA-OTIS Systemes de Transport

(21) Appl. No.: 09/746,133

(22) Filed: Apr. 3, 2001

(30) Foreign Application Priority Data
Dec. 24, 1999 (FR) 99 16480

(51) Int. Cl. B60V 3/04

(52) U.S. Cl. 104/23.2; 104/23.1

(57) ABSTRACT

A switching device for ground-effect vehicles, the said device comprising at least three sections of guidance and support tracks for the entry and exit of the vehicles, at least one of these tracks being the vehicle entry track, the said device comprising at least one support surface able to move between at least two positions, each of the said positions corresponding to a path by which the vehicles cross the switching device, the support surfaces of the sections of guide tracks being, for each path, in continuity with the movable support surface or surfaces.

The device is characterized in that it comprises at least one auxiliary guidance device, fixed over the major part of its length, for the vehicles when they pass vertically in line with the movable support surfaces.

Installation for transportation by ground-effect vehicles, notably for the automatic transportation of persons and/or products comprising at least one such device.

The invention relates to the technical field of systems for transporting persons and/or goods, by ground effect vehicles running on predefined tracks.

Different designs of such vehicles on air cushions are already known in the prior art.

Between 1965 and 1975, the engineer Bertin conceived and experimented with different versions of an aerotrain, an air cushion vehicle moving on a guide in the form of an inverted T. This project came to nothing.

For subsequent designs of air cushion trains, reference can be made, for example, to the following documents: WO-A-99/08918, WO-A-97/49592, WO-A-95/26896, WO-A-95/00377.

The invention relates more particularly but not exclusively to automatic systems for the transportation of persons.

As a concept, automatic systems for the transportation of persons (APM automatic people mover or AGT automatic guideway transit) have been known for about thirty years. The majority of APMs have a functioning such that the vehicles stop at a station, the interval between the vehicles being for example around 30 to 90 seconds.

Certain APMs have a semi-continuous functioning, the vehicle slowing down in the station to a speed compatible with the passengers getting on and off.

The majority of APMs installed in the 1970s were located in complexes such as business centres, airports, amusement parks and university campuses. Known as SLT (shuttle loop transit) these APMs comprise vehicles of moderate dimensions running on a system comprising few switching points.

Various propulsion techniques have been employed or envisaged: self-propulsion by electric motor or induction motor, or traction by cable.

In the case of traction by cable, the vehicles of the APMs known in the prior art are either fixed continuously to the tractor cable or provided with a clamp for gripping the tractor cable when the vehicle is stopped or in motion.

Various suspensions have been employed or envisaged for these APMs.

Usually it is a case of steel wheels, polyurethane tires or rubber tires.

Suspensions by magnetic levitation or air cushion are encountered appreciably more rarely, since they pose numerous technical problems, in particular for changing tracks.

The reliability of such transport systems must also be very high, around 99.5% and more, in particular when they are provided for the transportation of passengers in an airport, since the users of the APMs may be forced to pay extremely high penalties when breakdowns prevent the passengers of the APM from catching their aircraft.

The invention reveals a device for changing track for ground effect vehicles, in particular but not exclusively for air cushion vehicles, able to ensure the automatic transport of persons and/or products.

Devices for changing track for this type of vehicle are already known.

Thus the documents FR 1 575 761 and FR 1 399 587 describe devices comprising a movable element ensuring the change of track. A guidance element fixed to the movable element guides the vehicle when changing track.

There are also devices in which the guidance element is fixed, as described in the document GB 1 354 888.

These devices do however have certain drawbacks which the invention aims to resolve.

Notably the device of the invention improves the guidance of the vehicle when changing track and the reliability of the change of track.

Moreover, when changing track, the device does not require the movement of elements on the vehicle.

The invention relates, according to a first aspect, to a switching device for ground effect vehicles, the said device comprising at least three sections of guidance and support tracks for the entry and exit of the vehicles, at least one of these tracks being that for the entry of the vehicles, this device comprising at least one support surface movable between at least two positions, each of the said positions corresponding to a path by which the vehicles pass over the switching device, the support surfaces of the sections of guidance tracks, for each path, being in continuity with the movable support surface or surfaces.

The device is characterised in that it comprises at least one auxiliary guidance device, fixed over the major part of its length, for the vehicles when they pass vertically in line with the movable support surfaces.

According to different variant designs, the device has the following characteristics taken alone or in combination:

it comprises two simultaneously movable support surfaces, able to move with respect to two axes of rotation substantially perpendicular to their mid-planes;

the two movable support surfaces are substantially flat and extend in the same plane;

the support surfaces are able to move between two extreme positions corresponding to two paths over which the device passes provided with three vehicle entry and exit sections;

it comprises at least one device for guiding the vehicles when they pass vertically in line with the movable support surfaces;

the guidance device comprises at least one auxiliary rail cooperating with a roller or any other equivalent auxiliary guidance means, fixed to the chassis of the vehicles;

the auxiliary guidance roller is pressed against an external face of the auxiliary guidance rail, a main roller fixed to the chassis of the vehicles also being pressed against an internal guidance surface;

the internal guidance surface is formed by a flange of a rail placed above the auxiliary guidance rail.

The invention relates, according to a second aspect, to an installation for transportation by ground effect vehicles comprising at least one device as presented above.

According to certain embodiments;

the installation is of the type with vehicles driven by cable;

the cable is disposed so as to move in a central cavity delimited by two bands of shoulder whose top surfaces form a support plane for the vehicles;

the vehicles are provided with disengageable clamps for gripping and releasing the tractor cable.

Other objects and advantages of the invention will emerge during the following description of embodiments, a description which will be given with reference to the accompanying drawings, in which:

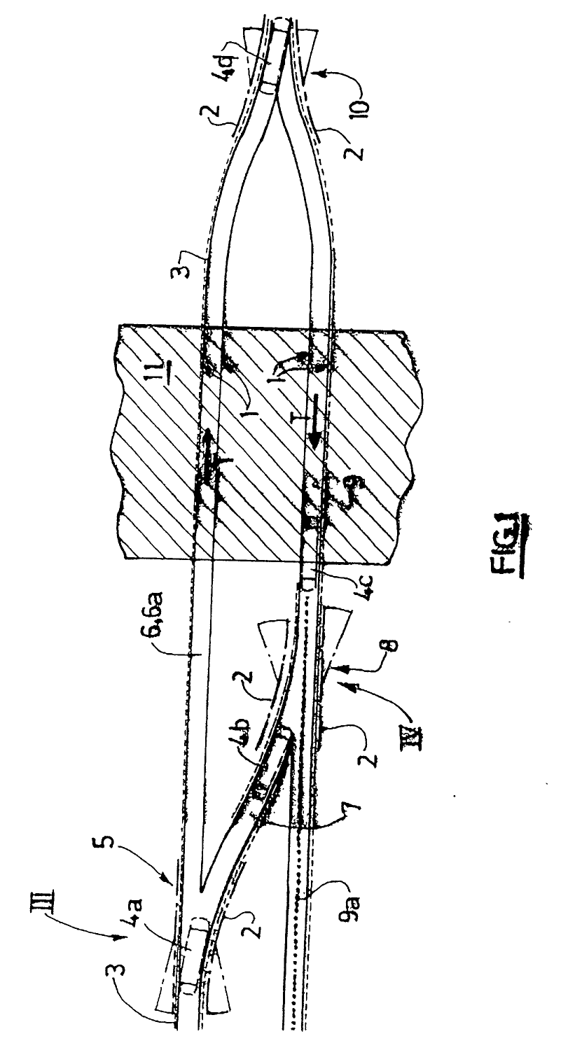

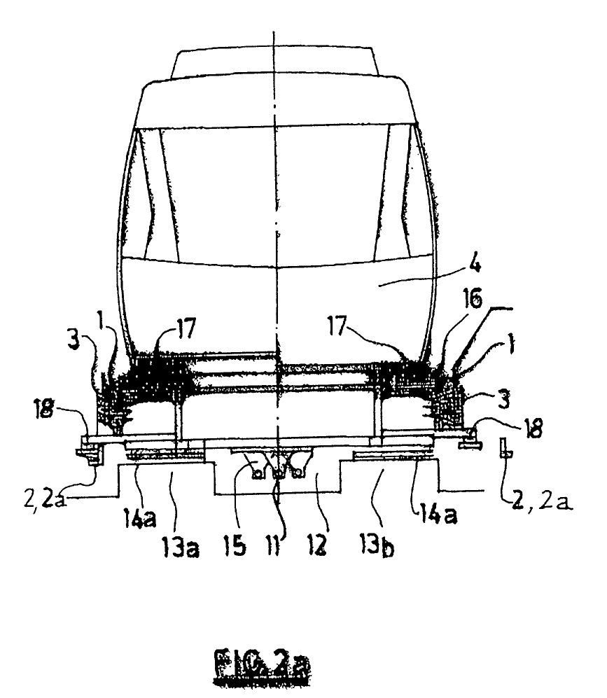

FIG. 1 is a schematic plan view of a track changing system according to one embodiment of the invention;

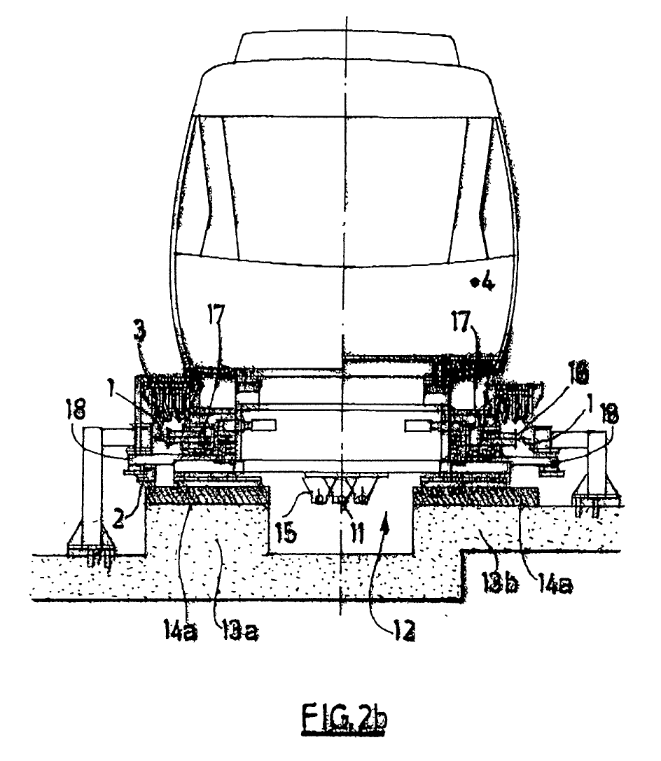

FIGS. 2a and 2b are two schematic front views of a ground effect transportation vehicle able to run on the tracks depicted in FIG. 1 according to two distinct embodiments;

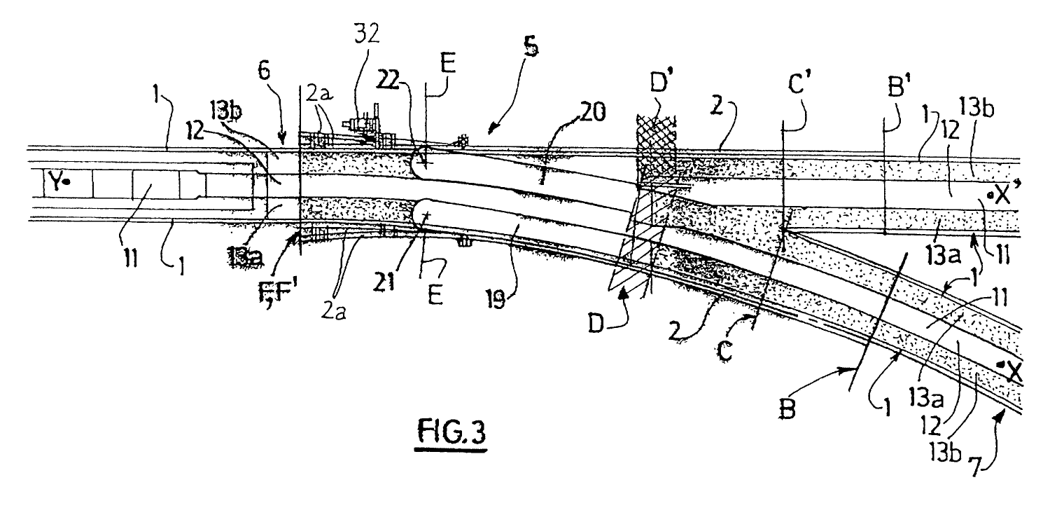

FIG. 3 is a more detailed plan view of the area referenced III in FIG. 1;

FIG. 3a is a more detailed plan view of the area referenced III in FIG. 1 according to another embodiment;

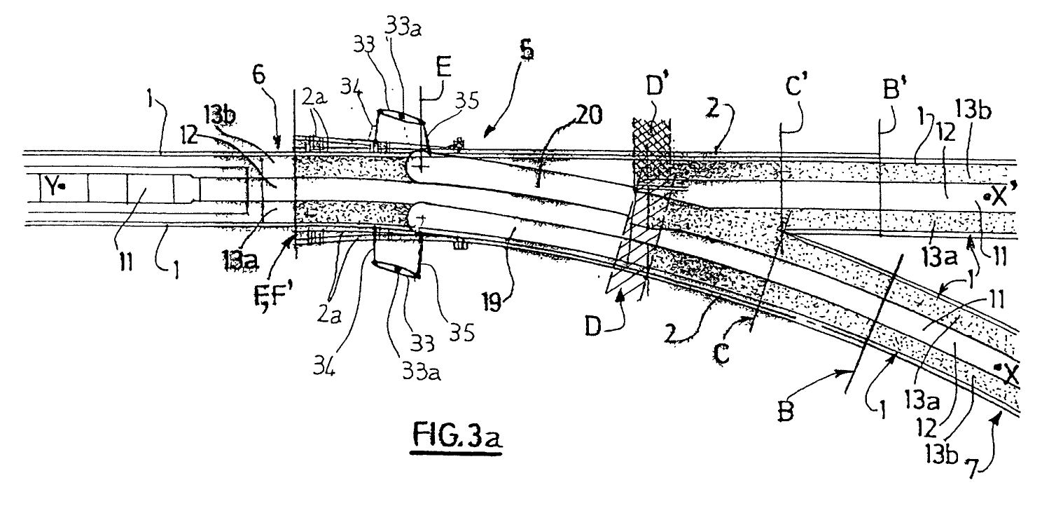

FIG. 4 is a more detailed plan view of the area referenced IV;

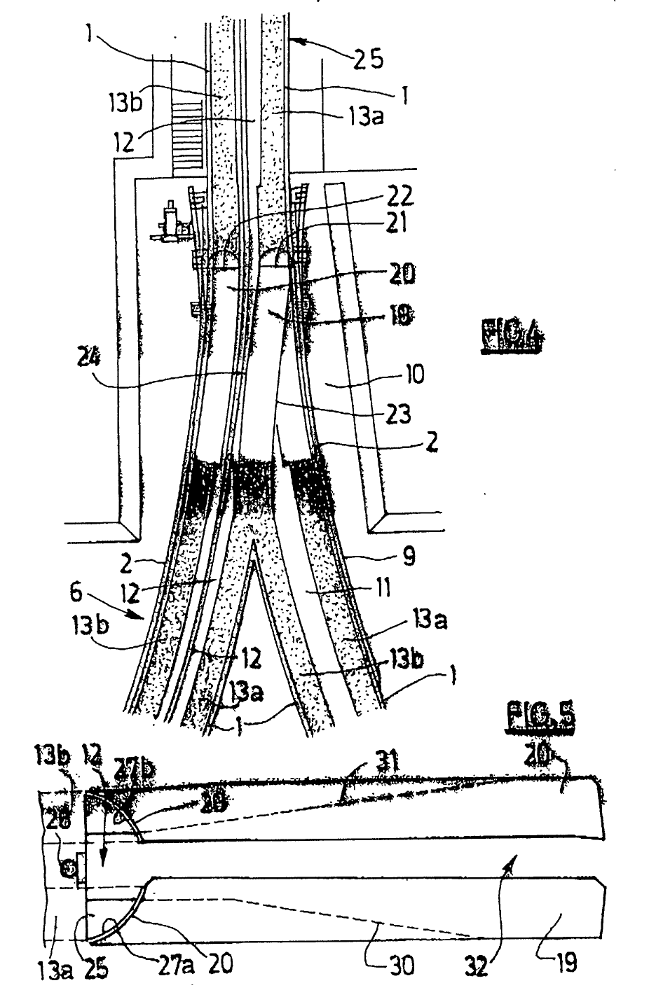

FIG. 5 is a detail plan view of the area referenced IV, according to a variant embodiment.

Reference is made first of all to FIG. 1.

The continuous lines show diagrammatically the position of the main guidance rails 1 for the ground effect vehicles running on the tracks.

The heavy broken lines show diagrammatically the position of the auxiliary guidance rails 2 for the ground effect vehicles, when they pass through the track change zones, hereinafter referred to as switching zones.

The fine broken lines show diagrammatically the position of the electric supply rails 3 for the transport installation.

Four vehicles 4a, 4b, 4c, 4d are shown diagrammatically in FIG. 1.

Hereinafter, the terms “upstream” and “downstream” will be employed with reference to the directions of movement indicated by the arrows T in FIG. 1.

From left to right in FIG. 1, there are found:

a first vehicle 4a passing through a first switching zone 5 connecting a first running track 6 to a transfer track 7;

a second vehicle 4b entering the transfer zone 7, after having passed through a second switching zone 8 which connects a second running track 9 to the transfer track 7;

a third vehicle 4c placed on the second running track 9, upstream of the second switching zone 8;

a fourth vehicle 4d placed in the third switching zone 10, which connects the first running track 6 to the second running track 9.

As is clear to experts, the line of the running tracks 6, 9 can be different from that illustrated, for the hatched system part 11 situated between the second switching zone 8 and the third switching zone 10.

The length of the transfer track 7 can be greater than that illustrated in FIG. 1.

The portion 9a of the second circulation track 9 situated downstream of the second switching zone 8 is, in the embodiment depicted, substantially parallel to the portion 6a of the first running track 6 situated upstream of the first switching zone 5.

In other embodiments, not illustrated, these track portions 6a, 9a are not parallel to each other.

Reference is now made to FIGS. 2a, 2b.

In the embodiments considered, the vehicles 4 are driven by a cable 11 running in a U-shaped central cavity 12 delimited by two strips of shoulder 13a, 13b substantially parallel to each other, the top faces 14a, 14b of these strips of shoulder forming a flight surface.

The vehicles 4 are provided with a device for coupling to the cable, fixed or disengageable.

In the embodiment described, this device comprises at least one disengageable clamp 15 projecting downwards from the chassis of the vehicles 4 for gripping the moving cable.

The principal guide rails 1 are, for example, I-shaped profiled sections, one of the flanges 16 of which is substantially opposite running rollers 17 fixed to the chassis of the vehicles 4. These principal guide rails 1 are fixed.

These rollers 17 are pressed against the flanges 16 on which they run.

Where applicable, a device makes it possible to measure, continuously or not, the force by which the rollers 16 are pressed against the guide rails 1.

The auxiliary guide rails 2 are, in the embodiments depicted in FIGS. 2a and 2b, angle pieces with an L-shaped transverse section.

Running rollers 18, fixed to the chassis of the vehicles, come into abutment from the outside against these angle pieces 2, when the vehicles pass through the switching zones.

In the embodiment in FIG. 2a, the principal guide rails 1 are situated below the electrical supply rails 3.

Whereas in the embodiment in FIG. 2b the principal guide rails 1 are situated below the electrical supply rails 3.

These switching zones are now described more particularly, with reference to FIGS. 3, 4 and 5.

In FIGS. 3 and 4, for the purposes of clarity, the travel support zones 13a, 13b are shaded.

Starting from a point X on the transfer track 7 and going towards the first switching zone 5, a vehicle 4 is first of all under conditions such that its left and right running rollers 17 are in abutment against the right and left principal guide rails 1.

Then, when the front of the vehicle arrives at the line B an auxiliary roller 18 on the vehicle comes into abutment against an auxiliary guide rail 2, placed below and opposite the left-hand principal guide rail 1.

When the front of the vehicles arrives at the line C, the right-hand principal guide rail 1 is interrupted and the vehicle is now guided only by the principal rail 1 and the left-hand auxiliary rail 2.

Then, when the front of the vehicle 4 enters the hatched zone D, the travel zones 13a, 13b are progressively replaced by two articulated travel zones 19, 20.

The front of the vehicle then arrives at the line E, substantially opposite vertical articulation axes 21, 22 of the movable travel zones 19, 20, and finds a second main guide rail 1.

The vehicle is then once again supported on two travel zones 13a, 13b of the first principal track 6 and the auxiliary guide rail does not extend beyond the end of the curve (line F in FIG. 3).

Each auxiliary guide rail 2 comprises a movable portion 2a, the major part of the length of the said guide rail 2 being fixed.

These movable portions 2a are articulated about vertical axes 2b and are disposed on each side of travel zones 13a, 13b, 19, 20.

With reference to FIG. 3, the free end of the said movable portions 2a corresponds substantially to the line F.

The articulation axis 2b of each portion 2a is situated at the other end of the said portion 2a.

The articulation axes 2b are disposed substantially between the vertical articulation axes 21, 22 of the movable flight zones 19, 20 and the free ends of the said zones 19, 20, close to the axes 21, 22.

The movement of the movable portions 2a is controlled by the movement of the movable travel zones 19, 20 so that the movements are synchronised.

The said control is produced by a mechanical connection between the movable zones 19, 20 and the movable portions 2a or by a motor 32, depicted in FIG. 3, controlling the movement of the portions 2a.

In FIGS. 3 and 3a, the two extreme positions of each portion 2a are depicted.

One embodiment of the mechanical connection between the movable zones 19, 20 and the movable portions 2a is depicted in FIG. 3a.

This connection is produced by a set of links 33, 34, 35 between each movable portion 2a and the corresponding movable zone 19, 20.

The link 33 is able to move in rotation about a vertical axis 33a situated substantially at its middle.

Each end of the link 33 is articulated at one end of the links 34, 35. The other end of the said links 34, 35 is articulated respectively on the portion 2a and on the corresponding movable zone 19, 20.

In the embodiment depicted, the link 34 is articulated on the portion 2a substantially in the middle part of the latter, the link 35 being articulated at the end of the movable zone 19, 20 close to its axis of rotation.

The movable portions 2a make it possible to guide a vehicle moving from point Y to point X or X′ (FIGS. 3, 3a).

When the vehicle moves from Y to X, the movable portion 2a situated on the side of the track going at X is put in place so as to come into engagement with the vehicle 4. The other movable portion 2a is then away from the vehicle 4 (see for example FIG. 2a).

Likewise, when the vehicle moves from Y to X′, the movable portion 2a situated on the side of the track going at X′ is put in place and comes into engagement with the vehicle 4.

Simultaneously with the putting in place of the movable portions 2a, the movable flight zones 19, 20 are oriented towards one or other track.

What has just been stated with reference to FIG. 3 for a vehicle passing from a point X on the transfer track 7 to a point Y on the first principal track can be transposed by an expert to other vehicle paths on the three switching zones in question.

Thus, in FIG. 3, starting from a point X′ situated on the principal track and going towards the point Y, the front of a vehicle 4 will encounter:

a line B′ on which right-hand auxiliary guidance takes place;

a line C′ on which the left-hand principal guidance disappears;

a zone D′ for passage from the travel zones 13a, 13b to the travel zones 19, 20;

a line E′ for the end of the movable travel zones 19, 20;

a line F′ for the end of the right-hand auxiliary guidance.

The structure of the second switching zone 8 can be similar, by symmetry, to that of the first switching zone.

In the third switching zone 10, the movable travel zones 19, 20 have lateral edges 23, 24 with a curvature intermediate between that of the first and that of the second running track 6, 9.

The third switching zone can for example connect these two running tracks 6, 9 to a single boarding or alighting station 25.

Drive means, not shown, rotate the flight surfaces 19, 20 around axes 21, 22, according to the required paths for the vehicles 4.

Naturally, the movable surfaces 19, 20 are in continuity with the support plane defined by the surfaces 13a, 13b of the tracks, upstream and downstream of the switching zone.

When, as depicted in FIGS. 2a, 2b, the vehicles are driven by cable, a transfer cable may be provided in each switching zone so as to ensure continuity of movement of the vehicle.

According to a variant embodiment illustrated in FIG. 5, the movable surfaces 19, 20 are mounted, for example permanently fixed, on a rigid chassis 25.

The chassis 25 is movable, and mounted so as to pivot about a vertical axis 26 located substantially at the centre of the central cavity 12.

In this way, the movement of the chassis 25 about its axis 26 allows the rotation of the surfaces 19, 20 in order to place them in continuity with the surfaces 13a, 13b of the tracks according to the path chosen for the vehicle 4.

In order to facilitate the rotation of the chassis whilst ensuring continuity of support on the vehicle 4, the ends 27a, 27b of the surfaces 13a, 13b of the tracks and the ends 28, 29 of the movable surfaces 19, 20, are substantially complementary in shape.

On the variant embodiment illustrated in FIG. 5, the ends 27a, 27b and 28, 29 are cylindrical in shape.

In addition, the chassis 25 is, in transverse section, substantially in a U shape, and comprises two longitudinal legs 30, 31 supporting respectively the surfaces 19, 20, and separated by a longitudinal cavity 32 situated in line with the central cavity 12.

According to a particular embodiment, the chassis 25 and the surfaces 19, 20 form a single piece.

1. A switching device for ground-effect vehicles, the said device comprising at least three sections of guidance and support tracks for the entry and exit of the vehicles, at least one of these tracks being the track for entry of the vehicles into the device, the device comprising at least one support surface movable between two positions, each of the said positions corresponding to a path by which the vehicles pass through the switching device, the support surfaces of the guide track sections being, for each path, in continuity with the movable support surface or surfaces, characterised in that it comprises at least one auxiliary guidance device, fixed over the major part of its length, for the vehicles when they pass vertically in line with the movable support surfaces.

2. A device according to claim 1, characterised in that it comprises two simultaneously movable support surfaces, movable with respect to two axes of rotation substantially perpendicular to their mid-planes.

3. A device according to claim 1, characterised in that it comprises a chassis carrying two support surfaces, the said chassis being movable, able to move with respect to an axis of rotation substantially perpendicular to the mid-plane of the said surfaces.

4. A device according to claim 2 or 3, characterised in that the two movable support surfaces are substantially flat and lie in the same plane.

5. A device according to any one of claims 1 to 4, characterised in that the support surfaces are movable between two extreme positions corresponding to two paths crossing the device provided with three vehicle entry and exit sections.

6. A device according to one of claims 1 to 5, characterised in that the guidance device comprises at least one auxiliary rail cooperating with a roller or any other equivalent auxiliary guidance means, fixed to the vehicle chassis.

7. A device according to claim 6, characterised in that the auxiliary guide roller is pressed against an external face of the auxiliary guide rail, a principal roller fixed to the chassis of the vehicles also being pressed against an internal guide surface.

8. A device according to claim 7, characterised in that the internal guide surface is formed by a flange on a rail placed above the auxiliary guide rail.

9. An installation for transportation by ground-effect vehicles, characterised in that it comprises at least one device according to any one of claims 1 to 8.

10. An installation according to claim 9, characterised in that it is of the type with the driving of vehicles by cable.

11. An installation according to claim 10, characterised in that the cable is disposed so as to move in a central cavity delimited by two bands of shoulder whose top surfaces form a vehicle support plane.

12. An installation according to claim 11, characterised in that the vehicles are provided with a device for coupling to the cable, fixed or disengageable, for gripping and releasing the tractor cable.
